(19) United States
(12) Patent Application Publication
(10) Pub. No.: US 2016/0018951 A1
(43) Pub. Date: Jan. 21, 2016

(54) CONTEXTUAL VIEW PORTALS

(71) Applicant: Microsoft Corporation, Redmond, WA (US)

(72) Inventors: Yekaterina Grabar, Seattle, WA (US); Daniel Dole, Seattle, WA (US); Dvir Horovitz, Redmond, WA (US); Saravanakumar Nagarajan, Kirkland, WA (US); Karl Tolgu, Seattle, WA (US); Casey D. Stein, Snohomish, WA (US); Priya Dandawate, Redmond, WA (US)

(21) Appl. No.: 14/333,741

(22) Filed: Jul. 17, 2014

(51) Int. Cl. G06F 3/0481; G09G 5/14; G09G 5/373; G06F 3/0484

(52) U.S. Cl. CPC G06F 3/0481; G06F 3/04845; G06F 3/04847; G09G 5/14; G09G 5/373; G09G 2354/00; G09G 2340/045; G09G 2340/0464

(57) ABSTRACT

One or more techniques and/or systems are provided for populating a map interface with a contextual view portal and/or for tracking contextual information. In an example, a map interface may be populated with a map canvas depicting a first location according to a first view setting (e.g., a city level view providing relatively lower level of detail of a city). A contextual view portal, corresponding to an area within the first location, may be populated within the map interface such as overlaying the map canvas. The contextual view portal may depict imagery of the area according to a second view setting (e.g., a photorealistic view setting, an aerial view setting, a street-side view setting, etc.). A user may relocate the contextual view portal to view imagery of various areas. A task tracking interface may be populated with contextual information associated with an area depicted by the contextual view portal.

### BACKGROUND

Many applications and/or websites provide information through map interfaces. For example, a videogame may display a destination for an avatar on a map canvas; a running website may display running routes through a web map interface; a mobile map app may display driving directions on a road map canvas; a realtor app may display housing information, such as images, sale prices, home value estimates, and/or other information on a map canvas; etc. Such applications and/or websites may allow a user to pan and/or zoom to view different content.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for populating a map interface with a contextual view portal and/or for tracking contextual information are provided herein. In an example of populating a map interface with a contextual view portal, a map interface may be populated with a map canvas corresponding to a first location. The map canvas may depict the first location according to a first view setting. Responsive to receiving an input through the map canvas regarding an area within the first location, the map interface may be populated with a contextual view portal corresponding to the area. The contextual view portal may be populated with imagery of the area according to a second view setting different than the first view setting. The contextual view portal may be populated with one or more contextual actions for the area. In an example, a position of the contextual view portal may be moved to a modified position, and second imagery of a second area corresponding to the modified position may be populated within the contextual view portal.

In an example of tracking contextual information, a map interface may be populated with a map canvas corresponding to a first location. The map interface may be populated with a contextual view portal corresponding to one or more areas within the first location. The contextual view portal may be populated with an open task tracking contextual action. Responsive to identifying a first selection of the open task tracking contextual action, a task tracking interface may be populated with a first entry corresponding to first contextual information associated with a first area depicted by the contextual view portal. Responsive to identifying a second selection of the open task tracking contextual action, the task tracking interface may be populated with a second entry corresponding to second contextual information associated with a second area depicted by the contextual view portal.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of populating a map interface with a contextual view portal.

FIG. 2A is a component block diagram illustrating an exemplary system for populating a map interface with a contextual view portal and/or for tracking contextual information, where a map interface is populated with a map canvas.

FIG. 2B is a component block diagram illustrating an exemplary system for populating a map interface with a contextual view portal and/or for tracking contextual information, where a map interface is populated with a contextual view portal.

FIG. 2C is a component block diagram illustrating an exemplary system for populating a map interface with a contextual view portal and/or for tracking contextual information, where a contextual view portal is populated with one or more contextual actions.

FIG. 2D is a component block diagram illustrating an exemplary system for populating a map interface with a contextual view portal and/or for tracking contextual information, where a contextual view portal is populated with photorealistic view imagery.

FIG. 2E is a component block diagram illustrating an exemplary system for populating a map interface with a contextual view portal and/or for tracking contextual information, where a contextual view portal is populated with street-side view imagery.

FIG. 2F is a component block diagram illustrating an exemplary system for populating a map interface with a contextual view portal and/or for tracking contextual information, where a contextual view portal is relocated.

FIG. 3 is a component block diagram illustrating an exemplary system for tracking contextual information.

FIG. 4 is an illustration of an exemplary computer readable medium wherein processor-executable instructions configured to embody one or more of the provisions set forth herein may be comprised.

FIG. 5 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for populating a map interface with a contextual view portal and/or for tracking contextual information are provided herein. Users may desire to view relatively higher resolution and/or photorealistic imagery of locations depicted by map canvases. However, many computing devices, such as mobile devices, may lack processing power, storage, and/or bandwidth to generate, store, and/or construct map canvases with such imagery. Accordingly, a contextual view portal (e.g., a user interface element) is constructed for a map canvas of a location, and imagery of a specific area within the location may be populated within the contextual view portal. Because the contextual view portal is populated with imagery of a specified area as opposed to imagery of the entire location, the contextual view portal may reduce processer utilization, storage, and/or bandwidth. In an example, a mapping component, configured to generate contextual view portals, may be locally hosted on a client device through which a contextual view portal may be displayed, and thus may mitigate bandwidth utilization. In another example, the mapping component may be hosted on a remote server configured to provide contextual view portals to the client device, and thus may mitigate client side memory and/or processer utilization.

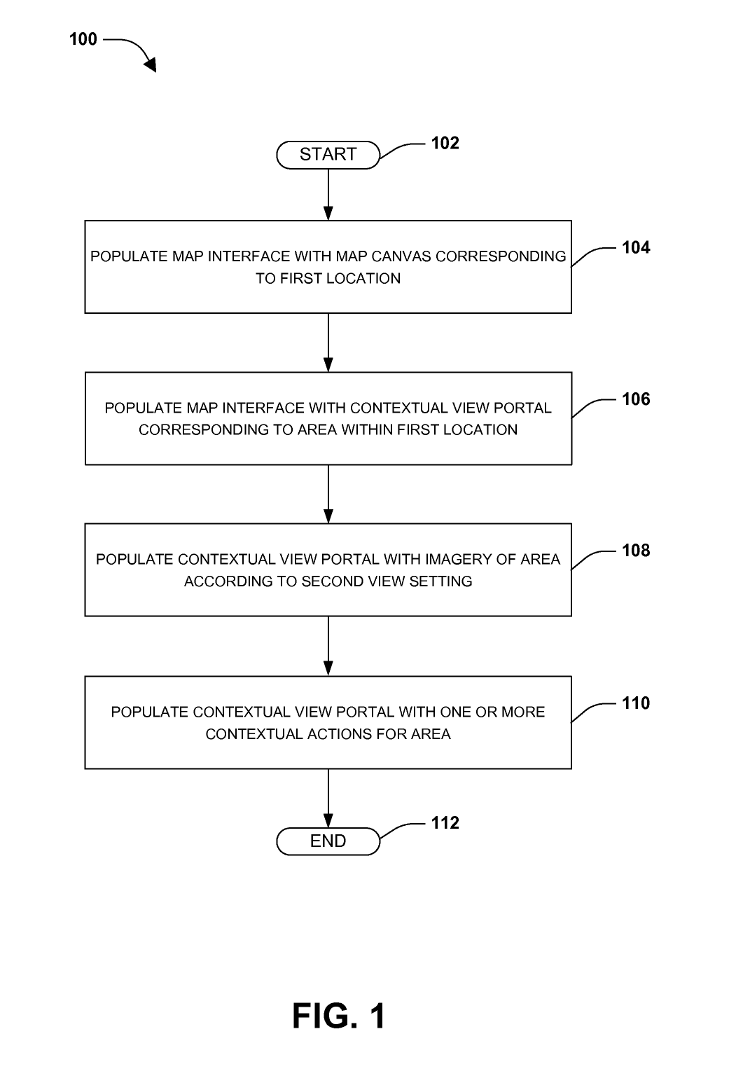

An embodiment of populating a map interface with a contextual view portal is illustrated by an exemplary method 100 of FIG. 1. At 102, the method starts. At 104, a map interface may be populated with a map canvas corresponding to a first location. The map canvas may depict the first location according to a first view setting (e.g., a zoom state view setting, a view orientation view setting, a level of granularity/detail view setting, etc.). For example, the map canvas may depict a downtown location according to a city level view setting (e.g., the map canvas may depict outlines of buildings, lines for streets, and/or other relatively low detail representations of entities within the downtown location).

At 106, responsive to receiving an input through the map canvas regarding an area within the first location (e.g., a touch gesture, a mouse click, a search query, or other input associated with a shopping district within the downtown location), the map interface may be populated with a contextual view portal (e.g., a bubble, lens, etc.) corresponding to the area. It may be appreciated that the contextual view portal may comprise any shape (e.g., a circular shape, oval shape, irregular shape), size (e.g., a size that encompasses the shopping district depicted by the map canvas), color (e.g., a translucent edge), and/or configuration (e.g., the contextual view portal may comprise a user interface element that overlays the map canvas and that allows the contextual view portal to be resizeable and/or moveable by a user).

At 108, the contextual view portal may be populated with imagery of the area according to a second view setting different than the first view setting. For example, the second view setting may specify a different level of detail, use of photography, a different view perspective, a different zoom level, and/or other visual setting that may be different than the first view setting. For example, the contextual view portal may be populated with photorealistic imagery of the shopping district (e.g., user photos of the shopping district acquired from a photo sharing network), aerial imagery of the shopping district, a rendered street-side view of the shopping district, etc.). In an example, an entity, associated with the area, may be identified (e.g., a clothing retail store). The contextual view portal may be populated with contextual information about the entity (e.g., coupons for the clothing retail store, an upcoming sale, a customer appreciation event, a news story, purchasing functionality, a social network profile of the clothing retail store, a social network message about the clothing retail store, task completion functionality such as tracking a package from a recent order, etc.).

In an example, a user may change a view perspective associated with the contextual view portal, such as to look around the area. For example, responsive to receiving portal view modification input (e.g., a touch gesture, selection of a view change user interface element, etc.), the view perspective of the contextual view portal may be modified based upon the portal view modification input (e.g., the contextual view portal may initially depict a store front of the clothing retail store, and may subsequently depict a roofline of the clothing retail store based upon the portal view modification input comprising a tilt and zoom input). The portal view modification input may comprise a pan input, a tilt input, a zoom input, and/or any other type of view modification input. In an example, the depiction of the first location (e.g., the downtown location) through the map canvas may be maintained according to the first view setting (e.g., depicted according to the city level view setting) despite the presentation of the contextual view portal and/or modifications to views of the contextual view portal.

In an example, a user may change a position of the contextual view portal in order to view other areas. For example, responsive to receiving relocation input associated with the contextual view portal (e.g., a touch gesture, selection of a position change user interface element, a search query, etc.), the position of the contextual view portal may be modified to a modified position based upon the relocation input. The contextual view portal may be populated with second imagery of a second area corresponding to the modified position (e.g., a depiction of a pharmacy located down the block from the clothing retail store).

At 110, the contextual view portal may be populated with one or more contextual actions for the area. In an example, the one or more contextual actions may comprise a driving directions contextual action, an add to favorites contextual action (e.g., used to save a reference to an entity such as the pharmacy), a share through social network contextual action, an open task tracking contextual action, a view option contextual action, a make reservation contextual action, a purchase contextual action, a call contextual action, a task completion contextual action, etc. In an example, the one or more contextual actions may be populated along a perimeter of the contextual view portal or at any other location in, on and/or around the map interface.

In an example, a selection of the open task tracking contextual action may be identified. A task tracking interface may be displayed. The task tracking interface may be populated with a first entry corresponding to contextual information associated with the area (e.g., information regarding the clothing retail store and/or other stores within the shopping district). Responsive to the contextual view portal corresponding to a second area of the map canvas (e.g., the user may relocate the contextual view portal to a theatre district of the downtown location), the task tracking interface may be populated with a second entry corresponding to second contextual information associated with the second area. In this way, the task tracking interface may be populated with one or more entries so that the user may track, save, recall, and/or share tasks (e.g., a locating clothing store task, a reserve theatre tickets task, etc.). In an example, a current state of the task tracking interface (e.g., the first entry, the second entry, and/or other entries) may be saved as a saved state. Responsive to receiving a request for the task tracking interface, the task tracking interface may be displayed based upon the saved state (e.g., populated with the first entry, the second entry, etc.). In this way, a user may recall the task tracking interface from various devices and/or during various computing sessions. For example, the saved state may correspond to one or more entries created based upon interaction with the map interface on a first computing device, and the task tracking interface may be displayed on a second computer device (e.g., the first entry and the second entry may have been created while the user was on a mobile device, and the user may later access the task tracking interface from a tablet device). In another example, the user may share the entries within the task tracking interface with other users (e.g., as an email, through a social network, through a map interface, etc.)

In another example, the contextual view interface may be populated with a view option contextual action corresponding to a view setting, such as a street-side view setting, an aerial imagery view setting, a rendered view setting, a photorealistic view setting, etc. Responsive to selection of the view option contextual action, the contextual view portal may be populated with second imagery corresponding to a view setting of the selected view option contextual action (e.g., the contextual view portal may be populated with photographs of the retail shopping store). In this way, the contextual view portal may provide a user with various view perspectives of an area within a location (e.g., the photorealistic view setting), which may be different than how the location is displayed through the map canvas (e.g., the city level view setting). At 112, the method ends.

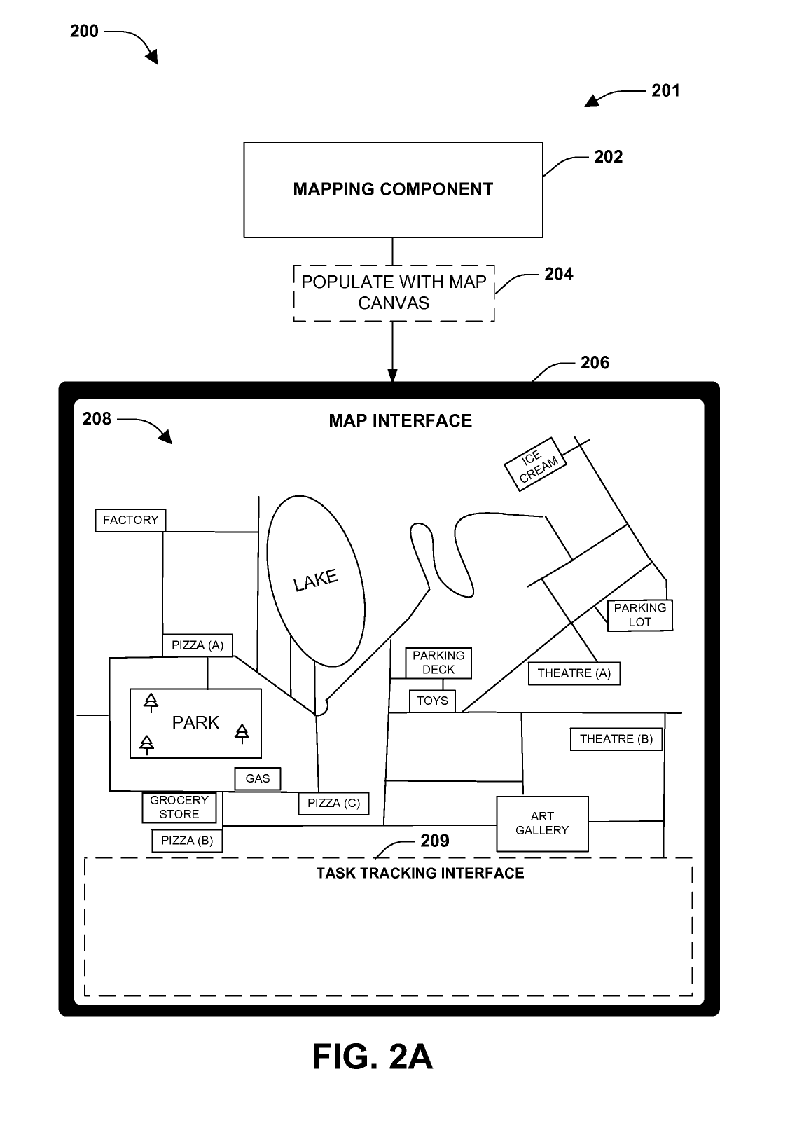

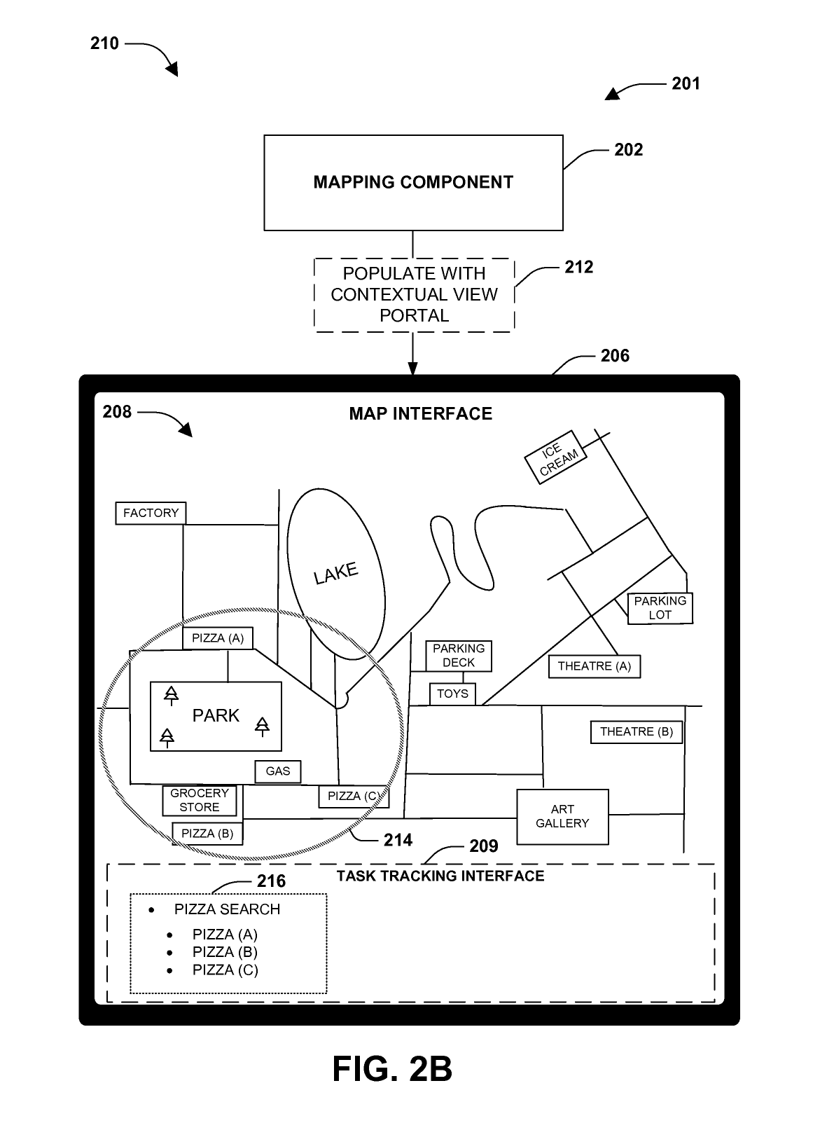

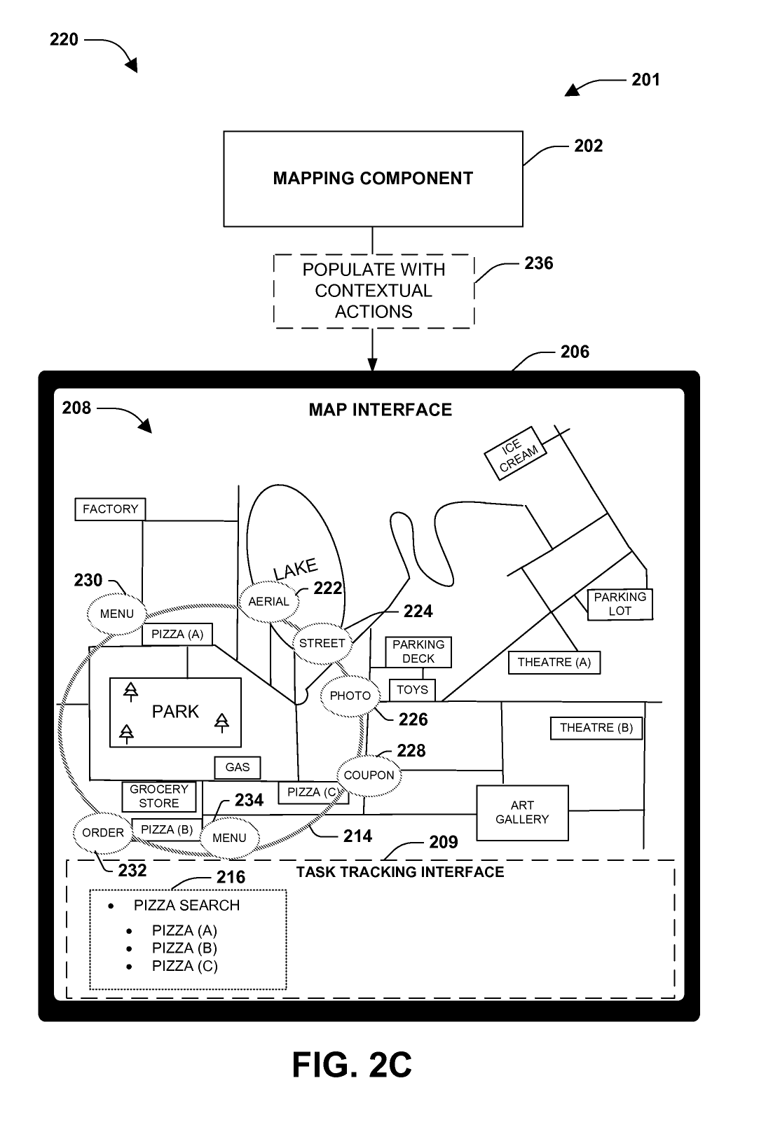

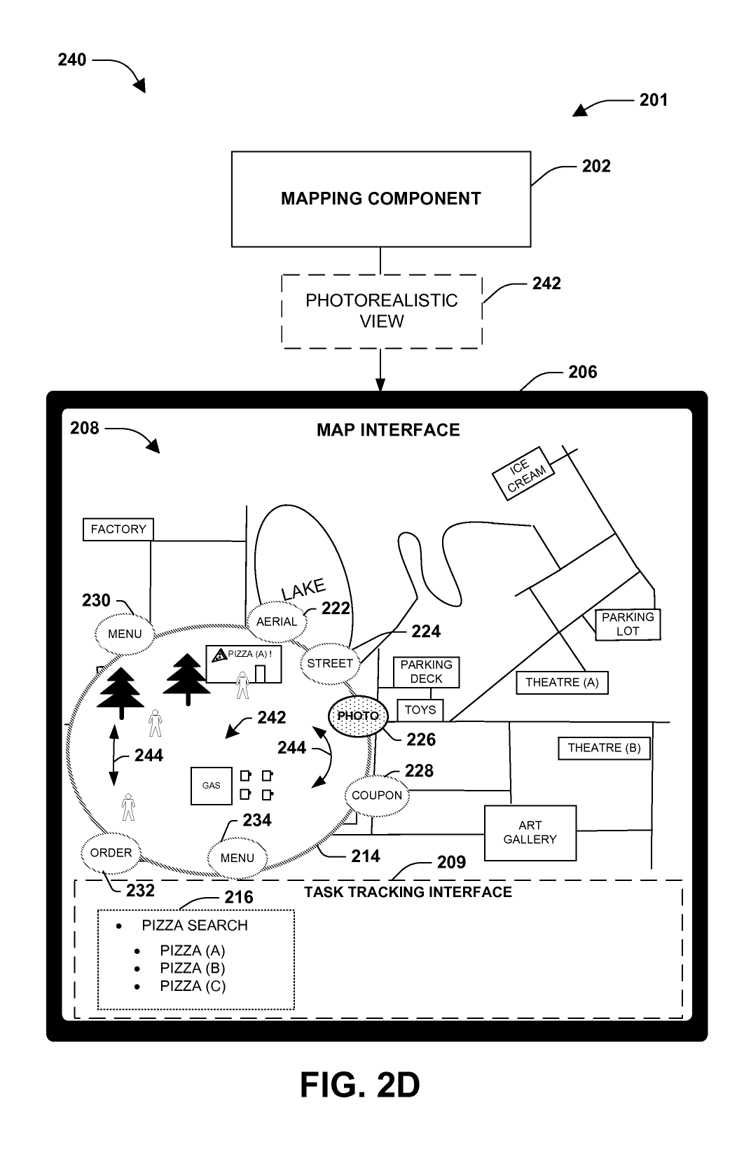

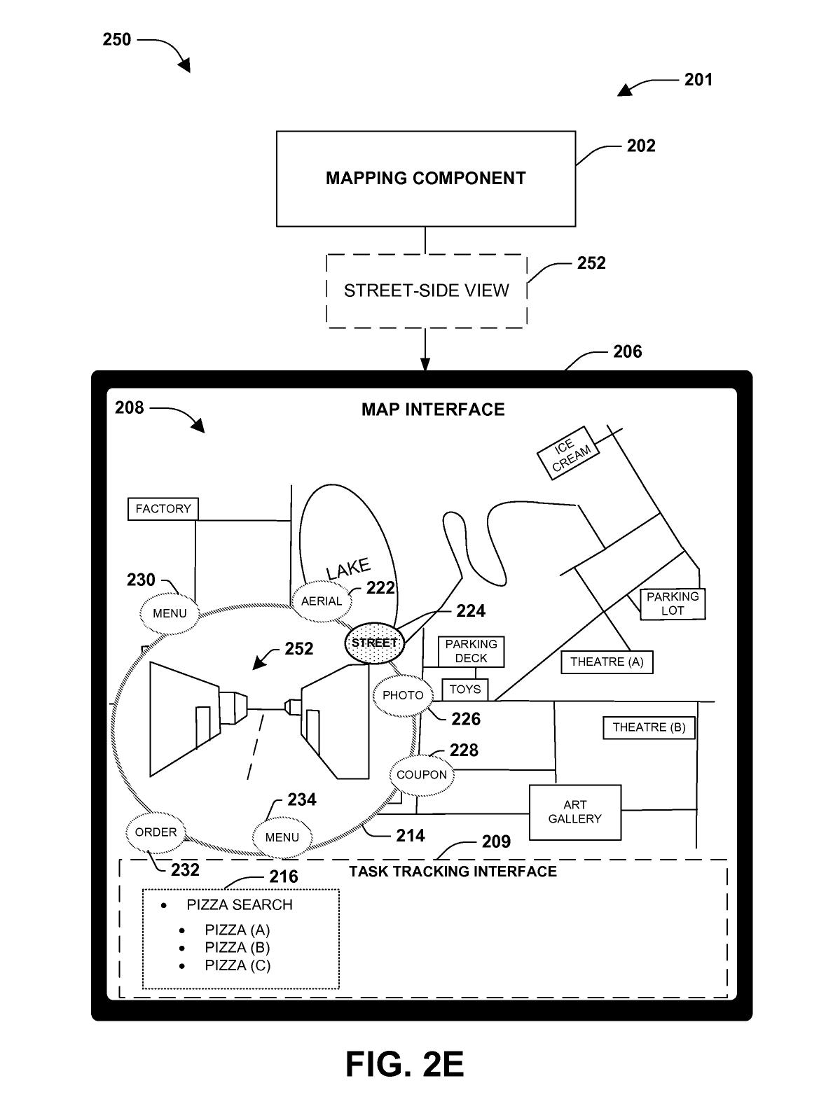

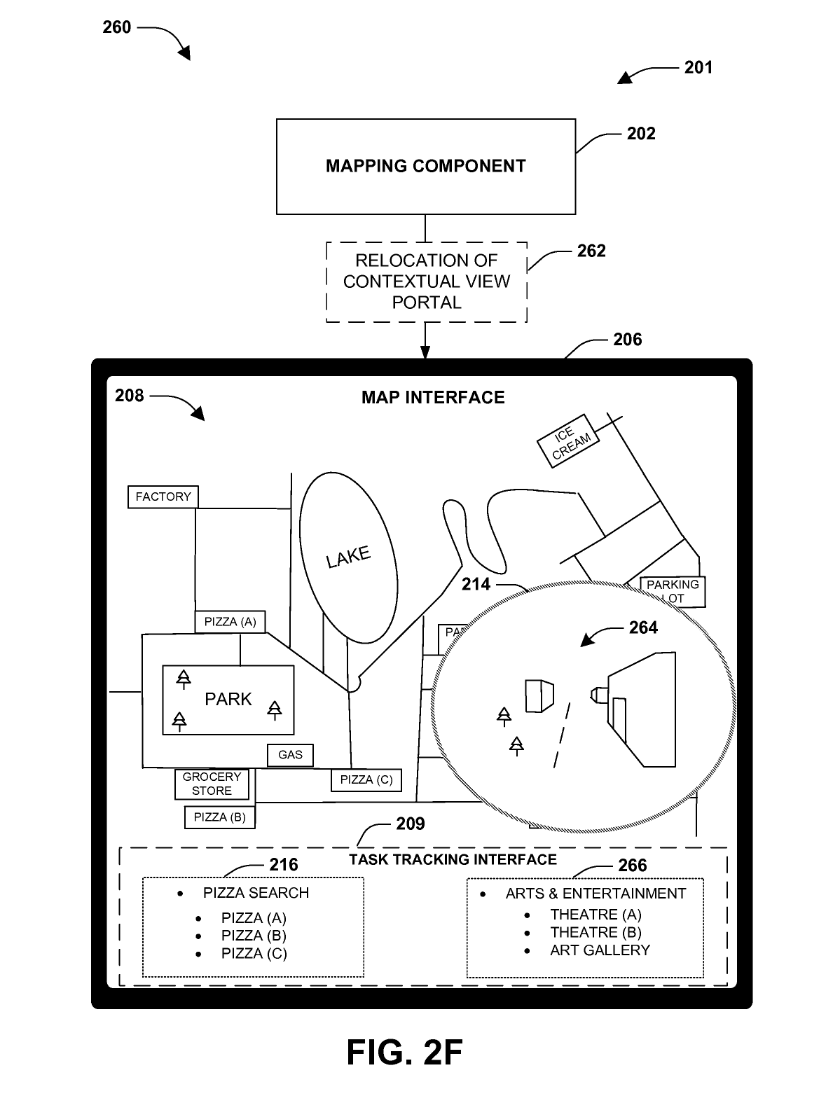

FIGS. 2A-2F illustrate examples of a system 201, comprising a mapping component 202 (e.g., hosted on a client device configured to display a map interface 206 or hosted on a remote server configured to provide map canvases to the client device), for populating a map interface with a contextual view portal and/or for tracking contextual information. FIG. 2A illustrates an example 200 of the mapping component 202 populating 204 the map interface 206 with a map canvas 208. For example, the map canvas 208 may depict a city according to a city level view setting (e.g., lines may be used to represent roads, squares and rectangles may be used to represent buildings, ovals may be used to represent lakes, etc.). A task tracking interface 209 may be provided through the map interface. Contextual information, entities (e.g., businesses), driving routes, tasks (e.g., toy store search results corresponding to a purchase birthday present task), and/or other information may be populated within the task tracking interface 209.

FIG. 2B illustrates an example 210 of the mapping component 202 populating 212 the map interface 206 with a contextual view portal 214 (e.g., a user interface element comprising a semi-transparent perimeter). In an example, the contextual view portal 214 may be generated to encompass a park area comprising one or more pizza shops based upon a user submitting a search query “pizza near the park”. In another example, the contextual view portal 214 may be generated to encompass the park area comprising the one or more pizza shops based upon the user selecting a pizza shop entity, such as the pizza shop (A) entity, depicted by the map canvas 208. In another example, the contextual view portal 214 may be generated based upon the user selecting the park area of the map canvas. The task tracking interface 209 may be populated with a first entry 216 corresponding to a pizza search task (e.g., based upon the search query “pizza near the park”). For example, the first entry 216 may comprise information related to the pizza shop (A) entity, a pizza shop (B) entity, and a pizza shop (C) entity depicted by the contextual view portal 214 (e.g., menus, coupons, a news story, a social network message, a social network profile, and/or other information corresponding to the pizza shop entities).

FIG. 2C illustrates an example 220 of the mapping component 202 populating 236 the contextual view portal 214 with one or more contextual actions for the park area (e.g., a contextual action may be populated along the perimeter of the contextual view portal 214, such as at positions proximate to corresponding entities). For example, a view pizza shop (A) entity menu contextual action 230 may be displayed for the pizza shop (A) entity. A view pizza shop (B) menu contextual action 234 and an order food contextual action 232 may be displayed for the pizza shop (B) entity. An obtain coupon contextual action 228 may be displayed for the pizza shop (C) entity. The contextual view portal 214 may be populated with an aerial view option contextual action 222, a street-side view option contextual action 224, a photorealistic view option contextual action 226, and/or other view option contextual settings (e.g., panorama view option contextual action, a rendered view option contextual action, etc.), which may be used for changing imagery of the contextual view portal 214.

FIG. 2D illustrates an example 240 of the mapping component 202 populating the contextual view portal 214 with photorealistic view imagery 242 of the park area based upon a selection of the photorealistic view option contextual action 226. For example, the photorealistic view imagery 242 may comprise one or more photos of the park area, such as photos of a park entity, a gas station entity, and the pizza shop (A) entity. In this way, the contextual view portal 214 may be populated with imagery of the park area according to a second view setting, such as a photorealistic view setting (e.g., photos), that is different than the first view setting (e.g., the city level view setting representing streets with lines, buildings with squares and rectangles, etc.) with which the map canvas 208 is displayed by the map interface 206. In an example, portal modification input elements 244 may be provided for the contextual view portal 214. The portal modification input elements 244 may be used to pan, tilt, zoom, and/or modify a view perspective of the photorealistic view imagery 242.

FIG. 2E illustrates an example 250 of the mapping component 202 populating the contextual view portal 214 with street-side view imagery 252 of the park area (e.g., a view perspective from the park towards a grocery store entity, the gas station entity, the pizza shop (B) entity, etc.) based upon a selection of the street-side view option contextual action 224. In this way, the contextual view portal 214 may be populated with imagery of the park area according to a third view setting, such as a street-side view setting, that is different than the first view setting (e.g., the city level view setting representing streets with lines, buildings with squares and rectangles, etc.) with which the map canvas 208 is displayed by the map interface 206.

FIG. 2F illustrates an example 260 of the mapping component 202 relocating 262 the contextual view portal 214. For example, relocation input associated with the contextual view portal may be received (e.g., a user may drag the contextual view portal to a theatre district area of the downtown location; the user may click the theatre district area; the user may submit a search query “nearby theaters”; etc.). Accordingly, the mapping component 202 may modify a position of the contextual view portal 214 to a modified position (e.g., from the park area to the theatre district area) based upon the relocation input. The contextual view portal 214 may be populated with second imagery of a second area corresponding to the modified position. For example, the contextual view portal 214 may be populated with street-side view imagery 264 of the theatre district. In this way, the contextual view portal 214 may be populated with second imagery of the theatre district area according to a street-side view setting that is different than the first view setting (e.g., the city level view setting representing streets with lines, buildings with squares and rectangles, etc.) with which the map canvas 208 is displayed by the map interface 206. In an example, the task tracking interface 209 may be populated with a second entry 266 corresponding to an arts and entertainment task (e.g., based upon the relocation input, such as the search query “nearby theatres”). The first entry 216, the second entry 266, and/or other entries may be tracked through the task tracking interface 209 (e.g., saved from and/or recalled to any device).

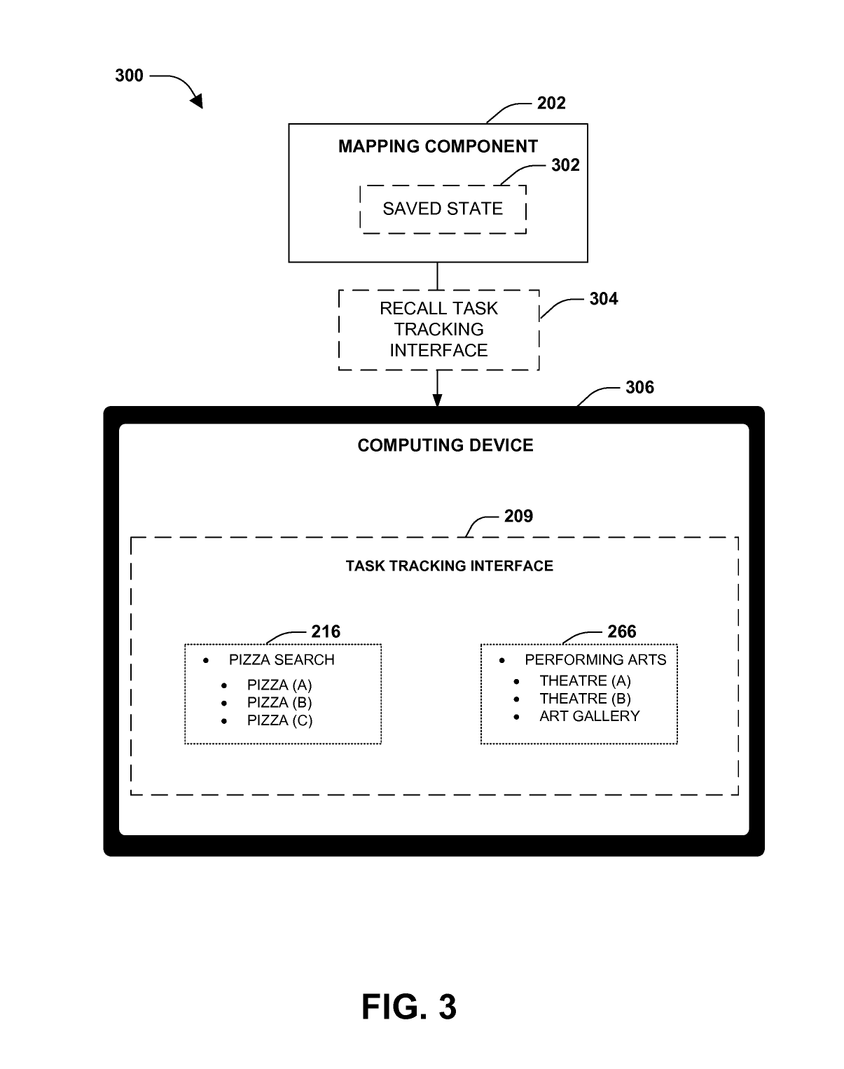

FIG. 3 illustrates an example of a system 300, comprising a mapping component 202, for tracking contextual information. In an example, the mapping component 202 may have saved a state of a task tracking interface 209 as a saved state 302. For example, the saved state 302 may comprise a first entry 216 corresponding to a pizza search task performed by a user of a map interface 206 provided through a mobile device (e.g., FIG. 2B), a second entry 266 corresponding to an arts and entertainment task performed by the user of the map interface 206 provided through the mobile device (e.g., FIG. 2F), and/or other entries corresponding to tasks performed by the user through various computing devices. In an example, a request to recall the task tracking interface 209 may be received from a computing device 306 (e.g., different than the mobile device). The mapping component 202 may recall 304 the task tracking interface 209 by displaying the task tracking interface 209, populated with the first entry 216 and the second entry 266, through the computing device 306. In this way, contextual information (e.g., associated with entities within areas depicted by imagery populated within contextual view portals) may be tracked and/or recalled.

According to an aspect of the instant disclosure, a method for populating a map interface with a contextual view portal is provided. The method includes populating the map interface with a map canvas corresponding to a first location. The map canvas may depict the first location according to a first view setting. Responsive to receiving an input through the map canvas regarding an area within the first location, the map interface may be populated with a contextual view portal corresponding to the area. The contextual view portal may be populated with imagery of the area according to a second view setting different than the first view setting. The contextual view portal may be populated with one or more contextual actions for the area.

According to an aspect of the instant disclosure, a system for tracking contextual information is provided. The system includes a mapping component. The mapping component may be configured to populate a map interface with a map canvas corresponding to a first location. The mapping component may be configured to populate the map interface with a contextual view portal corresponding to one or more areas within the first location. The mapping component may be configured to populate the contextual view portal with an open task tracking contextual action. Responsive to identifying a first selection of the open task tracking contextual action, the mapping component may be configured to populate the task tracking interface with a first entry corresponding to first contextual information associated with a first area depicted by the contextual view portal. Responsive to identifying a second selection of the open task tracking contextual action, the mapping component may be configured to populate the task tracking interface with a second entry corresponding to second contextual information associated with a second area depicted by the contextual view portal.

According to an aspect of the instant disclosure, a system for populating a map interface with a contextual view portal is provided. The system includes a mapping component. The mapping component may be configured to populate a map interface with a map canvas corresponding to a first location. The map canvas may depict the first location according to a first view setting. Responsive to receiving an input through the map canvas regarding an area within the first location, the mapping component may be configured to populate the map interface with a contextual view portal corresponding to the area. The mapping component may be configured to populate the contextual view portal with imagery of the area according to a second view setting different than the first view setting. Responsive to receiving relocation input associated with the contextual view portal, a position of the contextual view portal may be modified to a modified position based upon the relocation input. The mapping component may be configured to populate the contextual view portal with second imagery of a second area corresponding to the modified position.

According to an aspect of the instant disclosure, a means for tracking contextual information is provided. A map interface may be populated with a map canvas corresponding to a first location. The map interface may be populated with a contextual view portal corresponding to one or more areas within the first location. The contextual view portal may be populated with an open task tracking contextual action. Responsive to identifying a first selection of the open task tracking contextual action, a task tracking interface may be populated with a first entry corresponding to first contextual information associated with a first area depicted by the contextual view portal. Responsive to identifying a second selection of the open task tracking contextual action, the task tracking interface may be populated with a second entry corresponding to second contextual information associated with a second area depicted by the contextual view portal.

According to an aspect of the instant disclosure, a means for populating a map interface with a contextual view portal is provided. The map interface may be populated with a map canvas corresponding to a first location. The map canvas may depict the first location according to a first view setting. Responsive to receiving an input through the map canvas regarding an area within the first location, the map interface may be populated with a contextual view portal corresponding to the area. The contextual view portal may be populated with imagery of the area according to a second view setting different than the first view setting. The contextual view portal may be populated with one or more contextual actions for the area. Responsive to receiving a relocation input associated with the contextual view portal, a position of the contextual view portal may be modified to a modified position based upon the relocation input. The contextual view portal may be populated with second imagery of a second area corresponding to the modified position.

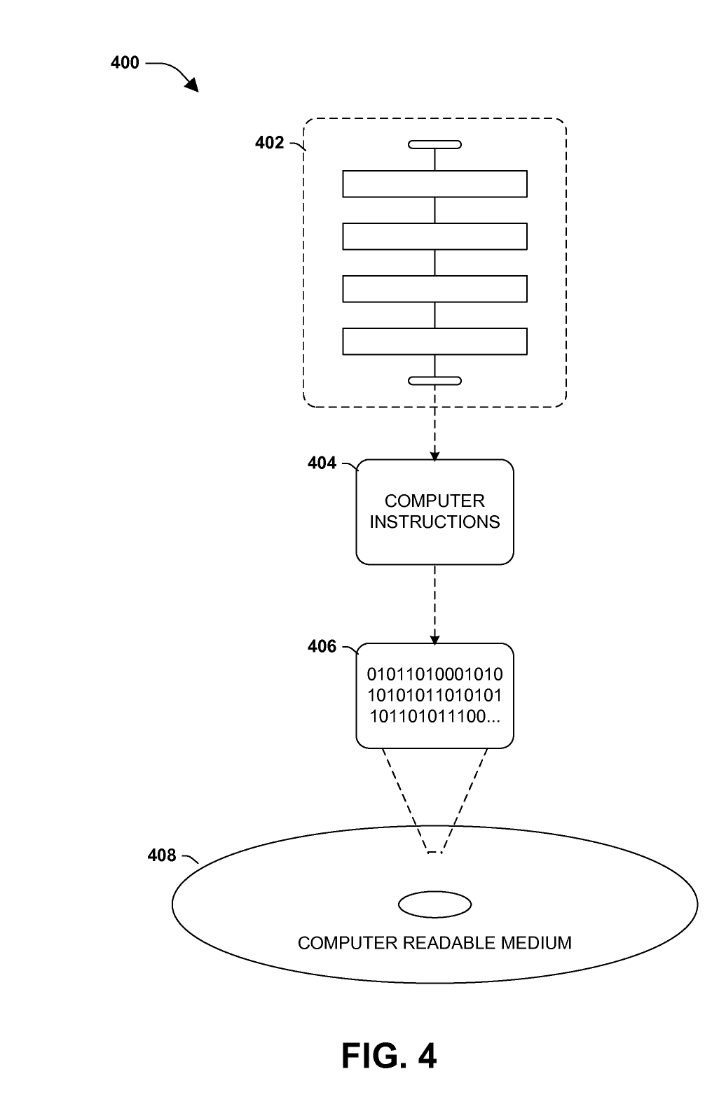

Still another embodiment involves a computer-readable medium comprising processor-executable instructions configured to implement one or more of the techniques presented herein. An example embodiment of a computer-readable medium or a computer-readable device is illustrated in FIG. 4, wherein the implementation 400 comprises a computer-readable medium 408, such as a CD-R, DVD-R, flash drive, a platter of a hard disk drive, etc., on which is encoded computer-readable data 406. This computer-readable data 406, such as binary data comprising at least one of a zero or a one, in turn comprises a set of computer instructions 404 configured to operate according to one or more of the principles set forth herein. In some embodiments, the processor-executable computer instructions 404 are configured to perform a method 402, such as at least some of the exemplary method 100 of FIG. 1 for example. In some embodiments, the processor-executable instructions 404 are configured to implement a system, such as at least some of the exemplary system 201 of FIGS. 2A-2F and/or at least some of the exemplary system 300 of FIG. 3, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

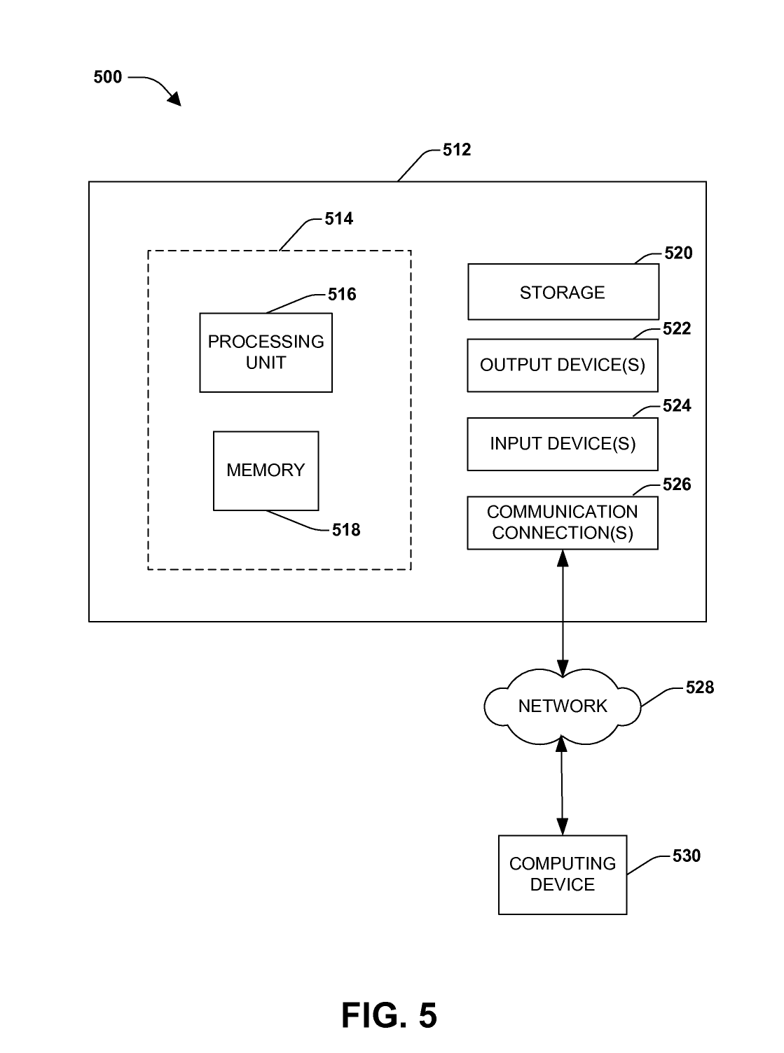

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 500 comprising a computing device 512 configured to implement one or more embodiments provided herein. In one configuration, computing device 512 includes at least one processing unit 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514.

In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Computer storage media does not, however, include propagated signals. Rather, computer storage media excludes propagated signals. Any such computer storage media may be part of device 512.

Device 512 may also include communication connection(s) 526 that allows device 512 to communicate with other devices. Communication connection(s) 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection(s) 526 may include a wired connection or a wireless connection. Communication connection(s) 526 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 512 may include input device(s) 524 such as keyboard, mouse, pen, voice input device, touch input device, infrared cameras, video input devices, and/or any other input device. Output device(s) 522 such as one or more displays, speakers, printers, and/or any other output device may also be included in device 512. Input device(s) 524 and output device(s) 522 may be connected to device 512 via a wired connection, wireless connection, or any combination thereof. In one embodiment, an input device or an output device from another computing device may be used as input device(s) 524 or output device(s) 522 for computing device 512.

Components of computing device 512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 512 may be interconnected by a network. For example, memory 518 may be comprised of multiple physical memory units located in different physical locations interconnected by a network.

Those skilled in the art will realize that storage devices utilized to store computer readable instructions may be distributed across a network. For example, a computing device 530 accessible via a network 528 may store computer readable instructions to implement one or more embodiments provided herein. Computing device 512 may access computing device 530 and download a part or all of the computer readable instructions for execution. Alternatively, computing device 512 may download pieces of the computer readable instructions, as needed, or some instructions may be executed at computing device 512 and some at computing device 530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1-20. (canceled)

21. A method for reducing processor, storage or bandwidth utilization through the presentation of a map interface, the method comprising:
physically generating, on a physical display device communicationally coupled to a computing device, a first map interface comprising a map canvas depicting a first location according to a first map view setting;
receiving, at the computing device, a user input identifying an area within the first location depicted by the map canvas; and
physically generating, on the physical display device, a second map interface representing an update to the first map interface in response to the user input, the second map interface comprising:
the map canvas depicting the first location according to the first map view setting;
a contextual view portal visually overlaid over a portion of the map canvas corresponding to the area such that the portion of the map canvas that is visually overlaid by the contextual view portal is, visually, wholly surrounded by the map canvas;
imagery of the area according to a second map view setting differing from the first map view setting, the imagery of the area being, visually, wholly within the contextual view portal; and
one or more user interface elements representative of one or more contextual actions for the area identified by the user input.

22. The method of claim 21, further comprising:
receiving, at the computing device, a second user input identifying a second area within the first location depicted by the map canvas, the second area differing from the area; and
physically generating, on the physical display device, a third map interface representing an update to the second map interface in response to the second user input, the third map interface comprising the contextual view portal visually overlaid over a portion of the map canvas corresponding to the second area such that the portion of the map canvas that is visually overlaid by the contextual view portal is, visually, wholly surrounded by the map canvas.

23. The method of claim 22, wherein the third map interface further comprises imagery of the second area according to a third map view setting differing from the first map view setting, the imagery of the second area being, visually, wholly within the contextual view portal.

24. The method of claim 21, wherein the one or more contextual actions comprise an open task tracking action, the method further comprising: physically generating, on the physical display device, a task tracking interface comprising a first entry that provides contextual information associated with the area.

25. The method of claim 24, further comprising:
receiving, at the computing device, a second user input identifying a second area within the first location depicted by the map canvas, the second area differing from the area; and
updating the task tracking interface to now comprise a second entry that provides contextual information associated with the second area.

26. The method of claim 21, further comprising the steps of:
identifying, with the computing device, an entity associated with the area; and
presenting, within the contextual view portal, contextual information about the identified entity.

27. The method of claim 26, wherein the contextual information about the identified entity comprises at least one of: a promotion offered by the identified entity, an event hosted by the identified entity, a social network profile associated with the identified entity, a social network message associated with the identified entity, a coupon redeemable at the identified entity or a reservation functionality for making a reservation at the identified entity.

28. The method of claim 21, wherein the one or more contextual actions comprise a view option contextual action for changing the second map view setting.

29. The method of claim 28, wherein the second map view setting is changed to one of a street-side view setting, an aerial imagery view setting or a photorealistic view setting.

30. A computing device comprising:
one or more processing units;
a display device; and
one or more computer storage media comprising computer-executable instructions which, when executed by the one or more processing units, cause the computing device to:
generate, on the display device, a first map interface comprising a map canvas depicting a first location according to a first map view setting;
receive a user input identifying an area within the first location depicted by the map canvas; and
generate, on the display device, a second map interface representing an update to the first map interface in response to the user input, the second map interface comprising:
the map canvas depicting the first location according to the first map view setting;
a contextual view portal visually overlaid over a portion of the map canvas corresponding to the area such that the portion of the map canvas that is visually overlaid by the contextual view portal is, visually, wholly surrounded by the map canvas;
imagery of the area according to a second map view setting differing from the first map view setting, the imagery of the area being, visually, wholly within the contextual view portal; and
one or more user interface elements representative of one or more contextual actions for the area identified by the user input.

31. The computing device of claim 30, wherein the one or more computer storage media comprising further computer-executable instructions which, when executed by the one or more processing units, cause the computing device to:
receive a second user input identifying a second area within the first location depicted by the map canvas, the second area differing from the area; and
generate, on the physical display device, a third map interface representing an update to the second map interface in response to the second user input, the third map interface comprising the contextual view portal visually overlaid over a portion of the map canvas corresponding to the second area such that the portion of the map canvas that is visually overlaid by the contextual view portal is, visually, wholly surrounded by the map canvas.

32. The computing device of claim 31, wherein the third map interface further comprises imagery of the second area according to a third map view setting differing from the first map view setting, the imagery of the second area being, visually, wholly within the contextual view portal.

33. The computing device of claim 30, wherein the one or more contextual actions comprise an open task tracking action; and wherein further the one or more computer storage media comprising further computer-executable instructions which, when executed by the one or more processing units, cause the computing device to generate, on the physical display device, a task tracking interface comprising a first entry that provides contextual information associated with the area.

34. The computing device of claim 33, wherein the one or more computer storage media comprising further computer-executable instructions which, when executed by the one or more processing units, cause the computing device to:
receive a second user input identifying a second area within the first location depicted by the map canvas, the second area differing from the area; and
update the task tracking interface to now comprise a second entry that provides contextual information associated with the second area.

35. The computing device of claim 30, wherein the one or more computer storage media comprising further computer-executable instructions which, when executed by the one or more processing units, cause the computing device to:
identify an entity associated with the area; and
present, within the contextual view portal, contextual information about the identified entity.

36. The computing device of claim 35, wherein the contextual information about the identified entity comprises at least one of: a promotion offered by the identified entity, an event hosted by the identified entity, a social network profile associated with the identified entity, a social network message associated with the identified entity, a coupon redeemable at the identified entity or a reservation functionality for making a reservation at the identified entity.

37. The computing device of claim 30, wherein the one or more contextual actions comprise a view option contextual action for changing the second map view setting.

38. The computing device of claim 37, wherein the second map view setting is changed to one of a street-side view setting, an aerial imagery view setting or a photorealistic view setting.

39. A graphical user interface physically generated on a physical display device communicationally coupled to a computing device, the graphical user interface comprising:
a map canvas depicting a first location according to a first map view setting;
a contextual view portal visually overlaid over a portion of the map canvas corresponding to a user identified area such that the portion of the map canvas that is visually overlaid by the contextual view portal is, visually, wholly surrounded by the map canvas;
imagery of the user identified area according to a second map view setting differing from the first map view setting, the imagery of the user identified area being, visually, wholly within the contextual view portal; and
one or more user interface elements representative of one or more contextual actions for the user identified area.

40. The graphical user interface of claim 39, wherein the contextual view portal is circular.
